(19) United States
(12) Patent Application Publication
(10) Pub. No.: US 2024/0288087 A1
(43) Pub. Date: Aug. 29, 2024

(54) RESTORABLE PYROTECHNIC VALVE

(71) Applicant: VIETTEL GROUP, Ha Noi City (VN)

(72) Inventor: DOAN HUNG NGUYEN, Ha Noi City (VN)

(73) Assignee: VIETTEL GROUP, Ha Noi City (VN)

(21) Appl. No.: 18/432,564

(22) Filed: Feb. 5, 2024

(30) Foreign Application Priority Data
Feb. 28, 2023 (VN) 1-2023-01270

(51) Int. Cl. F16K 31/02; F16K 27/02

(52) U.S. Cl. CPC F16K 31/02; F16K 27/02

(57) ABSTRACT

The present invention provides a pyrotechnic valve that can be recovered for reuse, which includes a ignitation assembly that is mounted to a stop ring assembly and a body assembly. The body assembly contains a piston assembly that plays the role of moving to cut off the interior tubing passageways of the elbow block when the ignition assembly works. The technical solution described in this invention provides a reliable and stable pyrotechnic valve design, providing a valve recovery solution that helps reduce the cost of testing.

### THE TECHNICAL FIELD OF THE INVENTION

The invention relates to a pyrotechnic valve that can be restored for reuse. The pyrotechnic valve that can be restored for reuse mentioned herein is applied to use for static test of the missile systems.

### THE TECHNICAL STATUS OF THE INVENTION

The pyrotechnic valve is an important part of the fuel system, hydraulic or pneumatic transmission in a missile system, military and aerospace equipment. It plays the role of opening or closing the fuel system for transmission to meet the system's working requirements. Normally, firebending valves have two main types: normally closed valves and normally open valves. With a normally closed valve, the initial operating state of the valve is closed, the fuel flow or gas flow cannot pass through. When the electric igniter on the valve is activated, the valve will return to the open state.

Some known inventions and technical solutions related to pyrotechnic valves are specifically as follows:

U.S. Pat. No. 4,619,284 of Nov. 28, 1986, The pyrotechnic valve according to the invention comprises one or more pyrotechnic devices able to produce gases under a high pressure, which has the effect of suddenly deforming a membrane equipped with a rigid weight. The latter projects a punch, which shears a tight end fitting, thus freeing the fluid passage. The membrane ensures a perfect seal between the fluid circulation zone and the zone containing the gases produced by the pyrotechnic devices.

U.S. Pat. No. 5,579,636 of Dec. 3, 1996, A pyrotechnic valve, igniter and combustion preheater for hybrid rocket motors is described. Particularly, the present invention comprises a ported connection means in which is mounted a solid charge of pyrotechnic material which provides a barrier to and obstructs the flow ports of the connection means to maintain the physical separation of the fluid propellant from the solid propellant. In operation, the solid charge is ignited and burns which burning consumes the charge and thereby removes the barrier to fluid propellant flow. The preferred pyrotechnic charge also ignites the solid propellant and thereby initiates combustion. The ported connection means may also include a preheater chamber in which is disposed a hollow or slotted cylinder of solid fuel which when burned, reacts with and heats the fluid oxidizer as it flows to the main combustion chamber to increase the ignitability and combustion efficiency of the solid fuel grain disposed therewithin.

The above inventions all propose pyrotechnic valve designs for different systems. However, there is no mention of the ability to recover for reuse during testing to check the overall system on the ground.

Therefore, the present invention proposes a pyrotechnic valve design that ensures reliable operation when activated. At the same time, provide a method to restore the product to serve testing and checking the overall system.

In terms of structure, like other types of pyrotechnic valves, this pyrotechnic valve is composed of a body, piston, electric igniter and inlet and outlet lines of the fuel (or gas) flow. The working characteristic of pyrotechnic valves is to rely on the large pressure pulse generated by activating the electric ignition to push the piston block into motion to cut off the details to open (or close) the inlet and outlet of the fluid flow. So it is a one-time use product. For a missile system or flight device, testing the system on the ground before flight testing is a mandatory requirement. This may have to happen many times, requiring a lot of time and expense. If there is no plan to reuse the pyrotechnic valve, a new set of products must be used each time the system is tested, which is costly. Therefore, the need for a pyrotechnic valve solution that ensures reliable operation and has a recovery method for reuse is essential.

### THE TECHNICAL NATURE OF THE INVENTION

The purpose of the invention is to provide a solution for a pyrotechnic valve that can be recovered for reuse. Specifically, the invention proposes a pyrotechnic valve, including:

Ignitation assembly: includes an o-ring and an electric igniter installed into the stop ring assembly, which creates pressure to push the piston assembly into motion, cutting off the pin and cutting off the two leads of the input elbow block, and the elbow block. output;

Stop ring assembly: includes a stop ring and an o-ring installed in the body assembly, in which the o-ring is to seal when combustion products are generated when activating the electric igniter;

Body assembly: includes valve body, locking pin and lower cup, the inner cavity of the body is cylinder-shaped so that the piston block can move easily;

Piston assembly: includes a piston that receives pressure pulses and moves down to cut the interior tubing passageways of the elbow block.

Inlet and outlet elbow block of fuel or gas: includes elbows and interior tubing passageways to transmit flow; rings for sealing;

In this invention, the method of restoring the pyrotechnic valve for reuse is by removing the parts that have been destroyed after operation including the electric igniter, the stop pin and the two actuators. Then cleaning the cylinder bore in the body assembly to remove soot and combustion products. Finally, installing the electric ignition parts, locking pins and two new leads into the body assembly so it can be reused.

### BRIEF DESCRIPTION OF THE DRAWING

FIG. 1: illustrates the general structure of the pyrotechnic valve;

FIG. 2: illustrates the detailed structure of the pyrotechnic valve;

FIG. 3: illustrates the general structure of the electric igniter;

FIG. 4: illustrates the structure of wrench assembly;

FIG. 5: illustrates describing the method of performing the pyrotechnic valve restoration.

### DETAILED DESCRIPTION OF THE INVENTION

The invention is described in detail below based on the accompanying drawings, which are intended to illustrate embodiments of the invention without limiting the scope of patent protection.

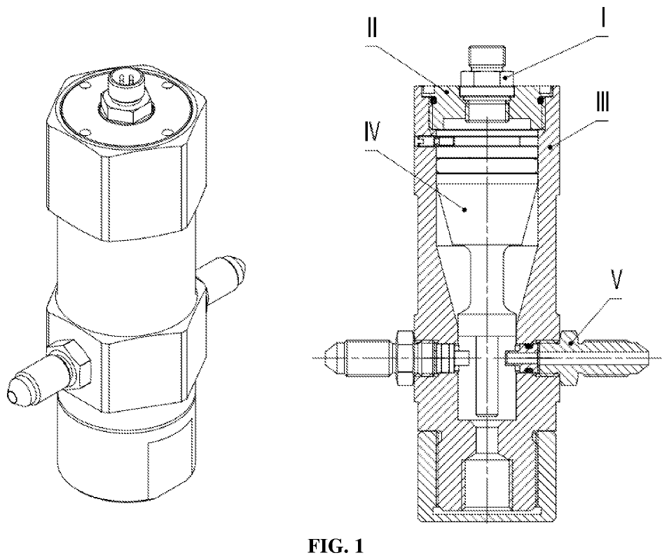

As shown in FIG. 1, the figure illustrates the general structure of the pyrotechnic valve. This includes the ignition assembly I installed into the stop ring assembly II, which creates pressure to push the piston assembly IV into motion, cutting off the locking pin and cutting off the two interior tubing passageway of the input elbow block, and the output elbow block V (hereinafter referred to as “lead elbow block”). The above assemblies and details are all securely fixed to body assembly III.

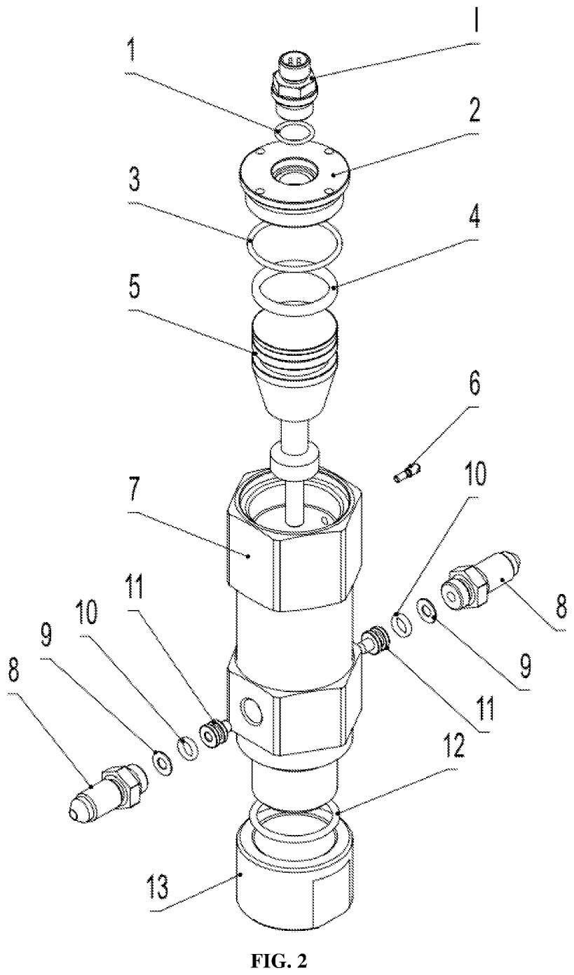

As shown in FIG. 2, the figure illustrates the detailed structure of the pyrotechnic valve. Specifically:

Ignition assembly I: includes the electric igniter and the first o-ring 1. Ignition assembly I has the function of creating pressure to push the piston assembly IV into motion to cut off the locking pin 6 and completely cut off the two interior tubing passageways 11 of two elbow blocks V. In which:

The electric igniter on the threaded body can be installed into stop ring 2 of stop ring assembly II. The first o-ring 1 is in the form of a rubber sealing ring, installed in the middle of the body of the electric igniter, with the function of sealing to prevent combustion products from leaking out after activating the electric igniter. The first o-ring 1 is selected to be made from rubber materials that can withstand high pressure and high temperature environments, including NBR rubber, Teflon, EPDM.

Ignition assembly I: includes the electric igniter and the first o-ring 1. The ignitation assembly I has the function of creating pressure to push the piston assembly IV into motion to cut off the locking pin 6 and completely cut off the two interior tubing passageways 11 of two elbow blocks V. In which:

The electric igniter on the threaded body can be installed into stop ring 2 of stop ring assembly II. The first o-ring 1 is in the form of a rubber sealing ring, installed in the middle of the body of the electric igniter, with the function of sealing to prevent combustion products from leaking out after activating the electric igniter. The first o-ring 1 is selected to be made from rubber materials that can withstand high pressure and high temperature environments, including NBR rubber, Teflon, EPDM.

The stop ring assembly II: includes stop ring 2 and second o-ring 3. In which:

Stop ring 2 is a stepped cylindrical part, threaded inside and outside. External thread to connect to body assembly III; internal thread to install the electric igniter of the ignition assembly I. The top of the stop ring 2 has four holes 90 degrees apart to facilitate disassembly. The underside of stop ring 3 is cut with a wide hole to create the initial space for combustion products when the electric igniter in ignition assembly I works. And the outside of the part has a groove at the end of the thread to install the second o-ring 3. Because stop ring 2 works directly in a high temperature and high pressure environment, it has high mechanical properties requirements for the material. Manufacturing materials, priority is given to using materials such as stainless steel SUS304, 40Cr, SCM-440.

The second o-ring 3 is in the form of a rubber sealing ring, installed in the middle of the groove on the outer surface of the stop ring 2, with the function of sealing to prevent combustion products from leaking out after activating the electric igniter; The second o-ring 3 is selected to be made from rubber materials that can withstand high pressure and high temperature environments, including NBR rubber, Teflon, EPDM.

Body assembly III includes body 7, locking pin 6, fourth o-ring 12 and lower cup 13. In which:

Body 7 is a hexagonal bar-shaped part, the middle part of body 7 is cylindrical. The two ends of the part are threaded; One end has an internal thread for mounting with the stop ring 2 of the stop ring assembly II, the other end has an external thread for mounting with the lower cup 13. The two hexagonal parts on the outside of the body 7 serve to facilitate assembly. In the upper hexagonal part, a threaded hole is created to install locking pin 6. The lower hexagonal part is created with a threaded stepped hole to assemble with two elbow blocks V. These two stepped hole systems require high concentricity with an allowable deviation of no more than 0.05 mm to ensure the cutting of interior tubing passageway 11 of piston 5. The inside of body 7 is shaped like a cylindrical hole at both ends and a transition taper in the middle with a taper angle of 26 degrees: 30 degrees.

These cylindrical holes serve to guide piston 5 during movement. The transition taper has two effects, one is to seal and separate the storage compartment (working compartment) of combustion products generated when activating an electric igniter and the fuel (or gas) transmission compartment. The second effect is to fix the piston assembly 5, preventing the piston from loosening or the piston being pushed back due to the pressure of the fuel (or gas) stream after the pressure of the combustion products in the chamber has decreased. The fixation of the piston is due to the large friction force that occurs when the two conical surfaces of body 7 and piston 5 are suddenly pushed together thanks to the pressure of the combustion products. Due to the special nature of the conical surface and two cylindrical surfaces in body 7, it requires high roughness to reach Ra0.63 or higher. Body 7 is made from highly durable and easy-to-process materials; Usually, priority is given to using SUS304 stainless steel, 40Cr steel or SMC-440.

Locking pin 6 is a screw-shaped part with one end threaded throughout to fit into the threaded hole on body 7. One end of locking pin 6 is cylindrical with a smaller size than the other end, threaded to insert into the groove of piston 5. Piston assembly IV before electric ignition works to fix this assembly. The transition part between the cylindrical end and the threaded end is created with a groove that concentrates stress to orient the cutting position when the fire valve works. Locking pin 6 is made from easily machined metal materials; Usually, stainless steel is preferred.

The fourth o-ring 12 is in the form of a rubber sealing ring, installed in the middle of the groove on the lower outer surface of the body 7, with the function of sealing to prevent fuel (or gas) flow from leaking out when the valve operates. movement; The fourth o-ring 12 is selected to be made from materials such as NBR rubber and silicon.

The lower cup 13 is a cylindrical cup-shaped part and has an internal threaded hole for mounting with body 7. On the outside of the part, two flat grooves are machined to facilitate the use of tools when disassembling and assembling the product.

Piston assembly IV has the function of cutting off the locking pin 6 to create an initial speed to cut the two ends of the elbow 8 of the elbow block V to open the flow to circulate according to the design function. And it has the function of sealing and separating the combustion product compartment and the fuel transmission compartment. Piston assembly IV includes piston 5 and third o-ring 4. In which:

Piston 5 is a cylindrical part, elongated at one end. The top of the large cylinder has two ring-shaped grooves, one groove to install the locking pin 6, the other groove to install the third o-ring 4. The end of the large cylinder head is beveled with a taper angle of 26 degrees=30 degrees. This taper angle must be equivalent to corresponding to the taper angle on the inner surface of the body 7. The small cylinder head has a stepped cylinder shape, in between these two stepped cylinder parts there is a knife-shaped edge with an angle of 45 degrees=60 degrees to the center of the piston 5. The edge is used to apply force and cut the ends of two the interior tubing passageway 11. Piston 5 works in a high temperature and pressure environment, so it has high requirements on the mechanical properties of the manufacturing materials, and is often preferred for use. materials such as SUS304 stainless steel or 40Cr steel; SMC-440.

The third o-ring 4 is in the form of a rubber sealing ring, installed in the middle of the groove on the large cylindrical head of the piston 5, with the function of sealing to prevent combustion products from flowing downward after activating the electric igniter. fuel compartment to avoid affecting the quality of fuel flow. The third o-ring 4 is selected to be made from materials such as NBR rubber, teflon, EPDM.

Input elbow block, output elbow block V (collectively called “elbow block”): these two blocks have completely the same structure, only different in function when operating. One block is the input, the other block is the fuel flow output. The elbow block V includes elbow 8, flat ring 9, o-ring 10 and interior tubing passageway 11. In which:

Elbow 8 is a hollow cylindrical part with threaded ends. One threaded end is for installation with body 7 of the body assembly IV, the other threaded end is used to connect to the pipeline of the overall system. The inside of the part is a cylindrical hole to transmit fuel or gas flow. The middle of the body of elbow 8 has a hexagonal shape to facilitate the use of tools when disassembling and assembling. Elbow 8 is made from materials with high requirements for mechanical properties, usually using SUS304 stainless steel is preferred.

Flat ring 9 is a rubber sealing ring shaped like a scarf, installed on interior tubing passageway 11 and elbow 8, with the function of sealing to prevent fuel or gas from leaking out into the environment while the valve is operating. Flat ring 9 is selected to be made from materials such as NBR rubber, Teflon, EPDM.

O-ring 10 is a round rubber sealing ring, installed in the middle groove of elbow 8, with the function of sealing to prevent fuel or gas from leaking out into the environment when the valve is working. It is selected and made from materials such as NBR rubber, Teflon, EPDM.

The interior tubing passageway 11 is a stepped cylindrical part, with a hollow inside and closed at one end. The closed head has a small size and a smaller thickness than the large head and is installed facing the inside of the body 7. This small head is the part that is cut off by the plunger when the electric igniter of the ignition assembly works. In the middle of the large end of the conduit there is a groove to install a round o-ring 10 for sealing. The interior tubing passageway 11 is made from stainless steel.

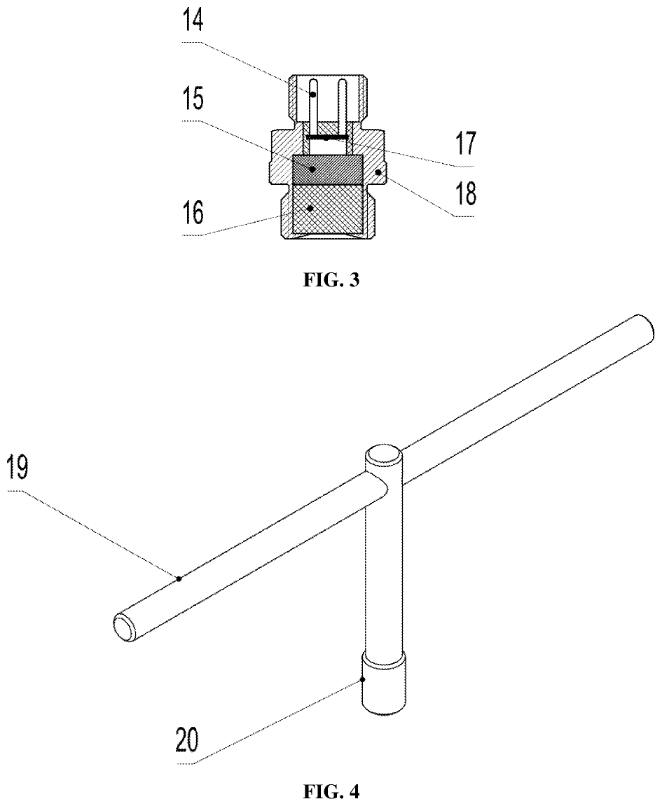

As shown in FIG. 3, the figure illustrates the general structure of the electric igniter. It includes the igniter body 18, the connector-bridge wire assembly 14, the ignition layer 17 and the powder dose. In which:

The igniter body 18 is made of stainless steel, both ends are threaded. One end is to connect to the control system's electrical jack, the other threaded end is to install with stop ring 2 of stop ring assembly II. Inside the igniter body 18 contains a connector-bridge wire assembly 14.

The connector-bridge wire assembly 14 includes four contact pins with soldered resistor wires in pairs, which has the effect of generating heat to ignite the ignition layer 17 when energized. Resistance wires are usually made of materials with high resistivity such as chromium-nickel alloy, volfram, constantan with diameters from 0.09 mm to 0.15 mm.

The ignition layer 17 is impregnated and covered on the surface of the connecting wires. When burned, it will burn fire powder dose 15 and fire booster dose 16 of the powder dose. The commonly used ignition layer 17 is composed of fire-sensitive drugs such as lead stypnate, lead azide, mercury fulminate or a mixture of the above compounds.

The powder dose consists of two layers: fire powder dose 15 and fire booster dose 16. Fire powder dose 15 has the effect of causing fire when receiving pressure pulses and sparks from the ignition layer 17. When this dose burns out, it will ignite the fire booster dose 16. Fire booster dose 16, when burned, will produce gas and high pressure pulses to push piston 5 to work properly. The ingredients of fire powder dose 15 are a mixture of lead tetra oxide (Pb3O4), silicon (Si) and NC glue. As for fire booster 16, due to the requirement to produce a large amount of gas to create high pressure, the commonly used ingredients are a mixture of potassium perchlorate (KCIO4), aluminum powder (Al) and NC glue.

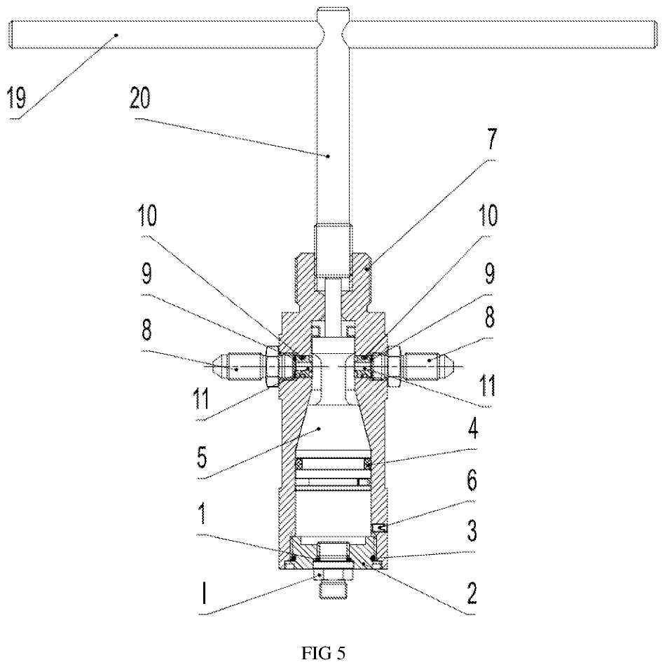

As shown in FIG. 4 the figure illustrates the structure of wrench assembly. It includes handle 19 and screw head 20. In which:

Handle 19 is a part in the shape of a long, uniform cylindrical bar, with both ends roughened to make it easier to hold when manipulating. It is made from C45 or CT3 carbon steel.

Screw head 20 is a step-shaft shaped part. The large end is threaded to screw into the thread on body 7 when used to restore the firebending valve. The small end has a hole to pass the handle 19 through before welding. 20 screw head is made from C45 or CT3 carbon steel.

When manufacturing a wrench, after welding two parts together according to requirements; The wrench is heat-treated to increase hardness and then the surface is treated to prevent surface oxidation after storage.

As shown in FIG. 5 the figure illustrates describing the method of performing the pyrotechnic valve restoration. In which:

Step 1: remove the parts/assemblies that are destroyed or no longer functional after the valve is operated. Those details/assemblies include ignitation assembly I, locking pin 6 of body assembly III, two the interior tubing passageway 11 of elbow block V.

Step 2: remove plunger 5; specifically:

Attach the pyrotechnic valve to the fixture, the threaded socket for the ignition assembly I is facing down.

Use a wrench to remove the lower cup from the stem assembly.

Install the wrench assembly into the threaded hole on body 7, then use your hand to turn the lever until plunger 5 leaves body 7.

Step 3: is to clean the surface; Specifically, clean the inner surface of body 7, piston 5 and prepare replacement materials.

Cleaning the inner surface of body 7 and piston 5 involves two steps including cleaning and drying. The cleaning step is to use clean rags, alcohol, and oil to remove combustion products that are still stuck to the surface such as soot, metal salts, and loose pieces of the locking pin 6 and interior tubing passageway 11 when cutting. The drying step is to use a clean rag to dry the inner surface of body 7 and piston 5.

Preparation of replacement materials such as electric igniter, locking pin 6 and two interior tubing passageway 11 is carried out carefully. The above details must be checked for quality and assembly ability.

Step 4: reassemble according to product drawings. In turn, install new interior tubing passageway 11, o-ring 10, flat ring 9 and elbows 8 onto body 7. Before installation, apply sealant to prevent threads from loosening. Tightening force for elbows 8 must be taken according to the specified standard table. Next, install the lower cup 13 and the fourth o-ring 12. Then install the piston assembly IV and the locking pin 6 into the body 7 so that the retaining pin 6 is fully inserted into the groove on the piston 5. Finally, install the stop ring assembly II and the ignitation assembly I contains the new electric igniter. Request to re-check the appearance and size of the valve after complete assembly.

With the structure as described above, the pyrotechnic valve operates as follows:

In the non-working state, the valve is normally closed. The V elbow blocks are always sealed, making it impossible for fuel or gas flow to pass through. At the same time, the cylindrical end of the locking pin 6 is inserted all the way into the groove on the piston 5, making it unable to move axially.

In the activated state, the electric igniter receives an activation command from the control system and will burn the ignition layer 17 and the powder dose (fire powder dose 15 and fire booster dose 16). The pressure generated by the combustion gas will push the piston 5 to cut off the locking pin 6 and move downward to cut off the small cylindrical end of the two interior tubing passageway 11. At this time, the fuel or gas flow from the input elbow block will flow out. output elbow block and ensure system functionality. At the same time, the two cones on body 7 and piston 5 will be fixed to each other due to the large friction force between these two cone faces.

### EFFICIENCY ACHIEVED BY THE INVENTION

This invention provides a pyrotechnic valve design that ensures reliable operation when activated and has the ability to be recovered for reuse to minimize costs during system research and development. And the invention has proposed a method to restore the product to serve tests and check the overall system to facilitate the process of exploiting and using the above pyrotechnic valve.

The invention is described in detail as above. However, it is clear that the person of ordinary skill in the field of invention is not limited to the embodiment described in the description of the invention. The invention may be implemented in modified or altered mode without falling outside the scope of the invention as defined by the claims. Therefore what is described in the description of the invention is for illustrative purposes only, and shall not impose any limitations on the invention.

What is claimed is:

1. A pyrotechnic valves that can be restored for reuse comprising:
an ignition assembly: including an o-ring and an electric igniter installed into a stop ring assembly, which creates pressure to push a piston assembly into motion, cutting off a pin and cutting off two leads of an input elbow block, and an elbow block output;
the stop ring assembly comprising: a stop ring and an o-ring installed in a body assembly, in which the o-ring is to seal when combustion products are generated when activating the electric igniter;
the body assembly comprising: a valve body, a locking pin and a lower cup, an inner cavity of the body assembly is cylinder-shaped so that a piston block can move easily;
the piston assembly: includes a piston that receives pressure pulses and moves down to cut an interior tubing passageway of the elbow block;
an inlet and outlet elbow block of fuel or gas: includes elbows and interior tubing passageways to transmit flow; and ring for sealing.

2. The pyrotechnic valve that can be restored for reuse according to claim 1, in which:
the ignition assembly is installed into the stop ring assembly, which has an effect of creating pressure to push the piston assembly into motion, cutting off the locking pin and cutting off the two interior tubing passageway of the input elbow block, and the output elbow block; wherein above assemblies and details are all securely fixed to the body assembly.

3. The pyrotechnic valve that can be restored for reuse according to claim 1, in which:
the ignition assembly including electric igniter and first o-ring: has the function of creating pressure to push the piston block into motion to cut off the locking pin and completely cut off the two interior tubing passageways of the two elbow blocks; the electric igniter on the threaded body is installed into the stop ring of the stop ring assembly; the first o-ring is in the form of a rubber sealing o-ring, installed in the middle of the body of the electric lighter, with the function of sealing to prevent combustion products from leaking out after activating the electric igniter; the first o-ring is selected to be made from rubber materials that can withstand high pressure and high temperature environments, including NBR rubber, Teflon, or EPDM.

4. The pyrotechnic valve that can be restored for reuse according to claim 1, in which:
the electric igniter includes four main components: an electric igniter body, a resistor-contact pile, an igniter and and igniter dose; wherein:
the electric igniter body is made of stainless steel, having two ends which are threaded, a first end is to connect to a control system's electrical jack, the second end is to install with the stop ring of the stop ring assembly, inside the igniter body contains a connector-bridge wire assembly;
the connector-bridge wire assembly includes four contact pins with soldered resistor wires in pairs, which has the effect of generating heat to ignite an ignition layer when energized, the wires are made of materials with high resistivity including chromium-nickel alloy, volfram, or constantan with diameters from 0.09 mm to 0.15 mm;
the ignition layer is impregnated and covered on the surface of the connecting wires, When burned, it will burn a fire powder dose and a fire booster dose of the powder dose, wherein the ignition layer is composed of fire-sensitive compounds including lead styphnate, lead azide, mercury phumiate or a mixture of the above compounds:
the powder dose consists of two layers: fire powder dose and fire booster dose, the powder dose has the effect of causing fire when receiving pressure pulses and sparks from the ignition layer, when this dose burns out, it ignites the fire booster dose, the fire booster dose, when burned, will produce gas and high pressure pulses to push piston to work properly, the ingredients of fire powder dose are a mixture of lead tetra oxide (Pb3O4), silicon (Si) and NC glue, the fire booster comprising are a mixture of potassium perchlorate (KCIO4), aluminum powder (Al) and NC glue.

5. The pyrotechnic valve that can be restored for reuse according to claim 1, in which:
the stop ring assembly includes a stop ring and a second o-ring, the ring is a stepped cylindrical part, threaded inside and outside, the outside thread to connect to the body assembly; the inside thread to install the electric igniter of the ignition assembly, a top of the stop ring has four holes 90 degrees apart to facilitate disassembly, an underside of stop ring is cut with a wide hole to create an initial space for combustion products when the electric igniter in the ignition assembly operates, and and outside of the part has a groove at an end of the thread to install the second o-ring, where therein stop ring comprises materials including stainless steel SUS304, 40Cr, SCM-440;
the second o-ring is in the form of a rubber sealing ring, installed in the middle of the groove on the outer surface of the stop ring, with the function of sealing to prevent combustion products from leaking out after activating the electric igniter; the second o-ring comprises rubber materials that can withstand high pressure and high temperature environments, including NBR rubber, Teflon, EPDM.

6. The pyrotechnic valve that can be restored for reuse according to claim 1, in which:
the body assembly includes a body, a locking pin, fourth o-ring and lower cup, in which:
the body is a hexagonal bar-shaped part, a middle part of the body is cylindrical, first and second ends of the hexagonal bar-shaped part are threaded; the first end has an internal thread for mounting with the stop ring of the stop ring assembly, the second end has an external thread for mounting with the lower cup, the two hexagonal parts on the outside of the body serve to facilitate assembly, in a upper portion of the hexagonal part, a threaded hole is created to install locking pin a lower portion of the hexagonal part is created with a threaded stepped hole to assemble with two elbow blocks an inside of the body is shaped like a cylindrical hole at two ends and a transition taper in a middle with a taper angle of 26 degrees=30 degrees;
these holes are cylindrical and serve to guide the piston during movement, the transition taper sealing and separating a storage compartment (working compartment) of combustion products generated when activating an electric igniter and the fuel (or gas) transmission compartment, and the second effect is to fix the piston assembly, preventing the piston from loosening or the piston being pushed back due to the pressure of the fuel (or gas) stream after the pressure of the combustion products in the chamber has decreased, the fixation of the piston is due to the large friction force that occurs when the two conical surfaces of body and piston are suddenly pushed together thanks to the pressure of the combustion products, roughness to reach Ra0.63 or higher is provided, the body is made from materials comprising SUS304 stainless steel, 40Cr steel or SMC-440:
the locking pin is a screw-shaped part with a first end threaded throughout to fit into a threaded hole on body one end of locking pin is cylindrical with a smaller size than another end, threaded to insert into the groove of piston, the transition part between the cylindrical end and the threaded end is created with a groove that concentrates stress to orient the cutting position when the pyrotechnic valve works; wherein the pin is made from easily machined metal materials comprising stainless steel;
the fourth o-ring is in the form of a rubber sealing ring, installed in the middle of the groove on the lower outer surface of the body, with the function of sealing to prevent fuel (or gas) flow from leaking out when the valve operates, movement, the fourth o-ring comprising materials selected from NBR rubber and silicon;
the lower cup is a cylindrical cup-shaped part and has an internal threaded hole for mounting with body, on an outside of the part, two flat grooves are machined to facilitate the use of tools when disassembling and assembling the product.

7. The pyrotechnic valve that can be restored for reuse according to claim 1, in which:
the piston assembly has the function of cutting off the locking pin to create an initial speed to cut two ends of the elbow of the elbow block to open a flow to circulate according to the design function, and having the function of sealing and separating the combustion product compartment and the fuel transmission compartment, the assembly includes a piston and third o-ring, wherein:
the piston is a cylindrical part, elongated at one end, a top of the cylinder has two ring-shaped grooves, one groove to install the locking pin, the other groove to install the third o-ring, an end of the cylinder head is beveled with a taper angle of 26 degrees=30 degrees, the taper angle being equivalent to corresponding to the taper angle on the inner surface of the body, a small cylinder head has a stepped cylinder shape, in between these two stepped cylinder parts there is a knife-shaped edge with an angle of 45 degrees=60 degrees to the center of the piston, the knife-shaped edge is used to apply force and cut the ends of two the interior tubing passageways, the piston works in a high temperature and pressure environment, and comprises materials such as SUS304 stainless steel or 40Cr steel; SMC-440;
the third o-ring is in the form of a rubber sealing ring, installed in the middle of the groove on the large cylindrical head of the piston, with the function of sealing to prevent combustion products from flowing downward after activating the electric ignite, fuel compartment to avoid affecting the quality of fuel flow, the third o-ring is selected to be made from materials comprising NBR rubber, Teflon, or EPDM.

8. The pyrotechnic valve that can be restored for reuse according to claim 1, in which:
the input elbow block, and the output elbow block (collectively called “elbow block”) have the same structure, only differing in function when operating, one block is the input, the other block is the fuel flow output, the elbow block V includes elbow, flat ring, o-ring and interior tubing passageway, wherein:
the elbow is a hollow cylindrical part with threaded ends, one threaded end is for installation with body of the body assembly, the other threaded end is used to connect to a pipeline of the overall system, the inside of the part is a cylindrical hole to transmit fuel or gas flow, the middle of the body of elbow 8 has a hexagonal shape to facilitate the use of tools when disassembling and assembling, the elbow is made from materials comprising SUS304 stainless steel;
the elbow flat ring is a rubber sealing ring shaped like a scarf, installed on interior tubing passageway and elbow, with the function of sealing to prevent fuel or gas from leaking out into the environment while the valve is operating, the elbow flat ring is made from materials comprising NBR rubber, Teflon, or EPDM;
the O-ring is a round rubber sealing ring, installed in the middle groove of elbow, with the function of sealing to prevent fuel or gas from leaking out into the environment when the valve is working, made from materials comprising NBR rubber, Teflon, or EPDM;
the interior tubing passageway is a stepped cylindrical part, with a hollow inside and closed at one end, the closed head has a small size and a smaller thickness than the large head and is installed facing the inside of the body, the small head is the part that is cut off by the plunger when the electric igniter of the ignition assembly works, in the middle of the large end of the conduit there is a groove to install a round o-ring for sealing, the interior tubing passageway is made from stainless steel.

9. The pyrotechnic valve that can be restored for reuse according to claim 1, in which:
the method of performing the pyrotechnic valve restoration comprises:
Step 1: remove the parts/assemblies that are destroyed or no longer functional after the valve works, including the ignition assembly, the locking pin of body assembly, two the interior tubing passageway of elbow block;
Step 2: remove plunger, this step comprising:
attach the pyrotechnic valve to the fixture, the threaded socket for the ignitation assembly facing down;
use a wrench to remove the lower cup from the stem assembly;
install the wrench assembly into the threaded hole on body, then use a hand to turn the lever until plunger leaves body;
Step 3: cleaning the surface, including, clean the inner surface of body, piston and prepare replacement materials;
cleaning the inner surface of body and piston involves two steps including cleaning and drying, the cleaning step is to use clean rags, alcohol, and oil to remove combustion products that are still stuck to the surface such as soot, metal salts, and loose pieces of the locking pin and interior tubing passageway when cutting, the drying step is to use a clean rag to dry the inner surface of body and piston;
preparing of replacement materials such as electric fire starter, locking pin and two interior tubing passageway is carried out carefully, checking for quality and assembly ability;
Step 4: reassemble, in turn comprising, installing new interior tubing passageway, o-ring, flat ring and elbows onto body, before installation, apply sealant to prevent threads from loosening, employing tightening force for elbows according to a specified standard table, installing the lower cup and the fourth o-ring installing the piston assembly and the locking pin into the body so that the retaining pin is fully inserted into the groove on the piston, installing the stop ring assembly and the ignitation assembly contains the new electric igniter, re-checking the appearance and size of the valve after complete assembly.
